(19) United States
(12) Patent Application Publication
(10) Pub. No.: US 2011/0154496 A1
(43) Pub. Date: Jun. 23, 2011

(54) Removable Apparatus and Method for Verifying an Executable File in a Computing Apparatus and Computer-Readable Medium Thereof

(76) Inventor: Chun Hsiang Cheng, Sanxia Township (TW)

(21) Appl. No.: 12/645,745

(22) Filed: Dec. 23, 2009

(51) Int. Cl. G06F 21/00; G06F 15/177; G06F 12/14

(52) U.S. Cl. 726/24; 713/2; 713/189; 726/22; 380/277; 711/115

(57) ABSTRACT

Apparatus and method for verifying an executable file in a computing apparatus by a removable apparatus and computer-readable medium thereof are provided. The removable apparatus boots up the computing apparatus and retrieves the executable file from the computing apparatus. After retrieving the executable file, a vendor-verify module and a digest-check module perform a vendor verification and a digest verification on the executable file, respectively. If the executable file fails in both the vendor verification and the digest verification, a file-link-detect module and an auto-run determination module check the behaviors of the executable file for deciding whether the executable file is suspicious.

### CROSS-REFERENCES TO RELATED APPLICATIONS

Not applicable.

### BACKGROUND OF THE INVENTION

1. Field of the Invention

The present invention relates to a removable apparatus and a method for verifying an executable file in a computing apparatus and a computer-readable medium thereof. More particularly, the present invention verifies whether an executable file in a computing apparatus is malicious by a trusted apparatus.

2. Descriptions of the Related Art

With the aid of computers, users are able to work more efficiently. For this reason, computers have become indispensable in the daily life of modern people. Accordingly, the computer security issues are getting more and more attentions nowadays. One important computer security issue is the ubiquitous malicious softwares (malware in short), such as computer virus.

On account of the computer virus causing great damages, numerous technologies for the detection and prevention of computer virus are hence developed. For instance, an anti-virus software is usually installed in a computer for detecting computer viruses. However, as the anti-virus software recognizes the virus by the unique “signature” of each virus, the abilities of anti-virus software for detecting virus has a great limitation corresponding to the virus database. In other words, most of the anti-virus software uses the “black list” approach for catching the virus. Therefore, if a new virus has been created, the anti-virus software could fail to protect the computers without the update of the virus database. Furthermore, the computer virus can exist in the computers before the anti-virus software being effective. Consequently, the computer virus can control the computer prior to the effectiveness of the anti-virus software or any other security means.

According to the descriptions above, a robust method for preventing the computers from the attacks of malware is still a great challenge in this field.

### SUMMARY OF THE INVENTION

An objective of the present invention is to provide a method for verifying a first executable file in a computing apparatus by a removable apparatus. The removable apparatus is virus-free. The method comprises the steps of (a) booting up the computing apparatus by the removable apparatus, (b) retrieving the first executable file from the computing apparatus by the removable apparatus, (c) determining that the first executable file comprises no vendor information regarding to a vendor of the first executable file by the removable apparatus, (d) calculating a message digest of the first executable by the removable apparatus by using a message digest algorithm, (e) the removable apparatus comprises no digest information being the same as the message digest, (f) detecting that the first executable file has a trigger relation with a second executable file in the computing apparatus by the removable apparatus, and (g) deciding that the first executable file is suspicious based on the detection of the trigger relation by the removable apparatus.

Another objective of the present invention is to provide a method for verifying an executable file in a computing apparatus by a removable apparatus. The removable apparatus is virus-free. The method comprises the steps of (a) booting up the computing apparatus by the removable apparatus, (b) retrieving the executable file from the computing apparatus by the removable apparatus, (c) determining that the executable file comprises no vendor information regarding to a vendor of the executable file by the removable apparatus, (d) calculating a message digest of the executable by the removable apparatus by using a message digest algorithm; (e) determining that the removable apparatus comprises no digest information being the same as the message digest, (f) determining that the executable file is an auto-run file by the removable apparatus, and (g) deciding that the executable file is suspicious based on the determination of the step (f) by the removable apparatus.

Another objective of the present invention is to provide a method for verifying an executable file in a computing apparatus by a removable apparatus. The removable apparatus is virus-free. The method comprises the steps of (a) booting up the computing apparatus by the removable apparatus, (b) retrieving the executable file from the computing apparatus by the removable apparatus, (c) determining that the executable file comprises no vendor information regarding to a vendor of the executable file by the removable apparatus, (d) calculating a message digest of the executable file by the removable apparatus by using a message digest algorithm, (e) determining that the message digest of the executable file is the same as a piece of digest information by the removable apparatus, and (f) deciding that the executable file is suspicious based on the determination of the step (e). The piece of digest information is stored in the removable apparatus.

Yet another objective of the present invention is to provide a method for verifying an executable file in a computing apparatus by a removable apparatus. The removable apparatus is virus-free. The method comprises the steps of (a) booting up the computing apparatus by the removable apparatus, (b) retrieving the executable file from the computing apparatus by the removable apparatus, (c) determining that the executable file comprises a piece of vendor information by the removable apparatus, the piece of vendor information comprising a vendor information part, a designated part, and an encrypted part, (d) retrieving a vendor public key according to the vendor information part by the removable apparatus, the vendor public key being stored in the removable apparatus, (e) decrypting the encrypted part to a decrypted part by the removable apparatus by using the vendor public key, (f) determining that the decrypted part is different from the designated part, and (g) deciding that the executable file is suspicious based on the determination of the step (f).

Another objective of the present invention is to provide a method for verifying an executable file in a computing apparatus by a removable apparatus. The removable apparatus is virus-free. The method comprises the steps of (a) booting up the computing apparatus by the removable apparatus, (b) retrieving the executable file from the computing apparatus by the removable apparatus, (c) determining that the executable file comprises a piece of vendor information by the removable apparatus, the piece of vendor information comprising a vendor information part, a designated part, and an encrypted part, (d) retrieving a vendor public key according to the vendor information part by the removable apparatus, the vendor public key being stored in the removable apparatus, (e) decrypting the encrypted part to a decrypted part by the removable apparatus by using the vendor public key, (f) determining that the decrypted part is the same as the designated part, and (g) deciding that the executable file is trustworthy based on the determination of the step (f).

Yet another objective of the present invention is to provide a method for verifying an executable file in a computing apparatus by a removable apparatus. The removable apparatus is virus-free. The method comprises the steps of (a) booting up the computing apparatus by the removable apparatus, (b) retrieving the executable file from the computing apparatus by the removable apparatus, (c) determining that the executable file comprises no vendor information regarding to a vendor of the executable file by the removable apparatus, (d) calculating a first message digest of the executable file by the removable apparatus by using a message digest algorithm, (e) determining that the removable apparatus comprises no digest information being the same as the message digest, (f) shutting down the computing apparatus by the removable apparatus, (g) retrieving the executable file from the computing apparatus by the removable apparatus after the computing apparatus is booted up by the computing apparatus, (h) calculating a second message digest of the executable file by the removable apparatus by using the message digest algorithm, (i) deciding that the first message digest and the second message digest of the executable file are different; and (j) deciding that the executable file is a malware based on the result of the step (i) by the removable apparatus.

Each of the methods of the present invention can be achieved by a plurality of computer instructions stored in a computer-readable medium. The computer instructions comprise a plurality of codes. When the codes are executed, the codes enable a device, such as a removable apparatus, to execute any of the methods of the present invention for verifying a first executable file in a computing apparatus described in the preceding paragraphs.

A further objective of the present invention is to provide a removable apparatus for verifying a first executable file in a computing apparatus. The removable apparatus is virus-free. The removable apparatus comprises an initialization module, a file-scan module, a vendor-verify module, a digest-check module, and a file-link-detect module. The initialization module is for booting up the computing apparatus. The file-scan module is for retrieving the first executable file from the computing apparatus. The vendor-verify module is for determining that the first executable file comprises no vendor information regarding to a vendor of the executable file. The digest-check module is for calculating a message digest of the first executable by the removable apparatus by using a message digest algorithm and for determining that the removable apparatus comprises no digest information being the same as the message digest. The file-link-detect module is for detecting that the first executable file has a trigger relation with a second executable file in the computing apparatus and for deciding that the first executable file is suspicious based on the detection of the trigger relation.

A further objective of the present invention is to provide a removable apparatus for verifying an executable file in a computing apparatus. The removable apparatus is virus-free. The removable apparatus comprises an initialization module, a file-scan module, a vendor-verify module, a digest-check module, and an auto-run module. The initialization module is for booting up the computing apparatus. The file-scan module is for retrieving the executable file from the computing apparatus. The vendor-verify module is for determining that the executable comprises no vendor information regarding to a vendor of the executable file. The digest-check module is for calculating a message digest of the executable by the removable apparatus by using a message digest algorithm and for determining that the removable apparatus comprises no digest information being the same as the message digest. The auto-run determination module is for determining that the executable file is an auto-run file and for deciding that the executable file is suspicious based on the determination of the executable file being the auto-run file.

A further objective of the present invention is to provide a removable apparatus for verifying an executable file in a computing apparatus. The removable apparatus is virus-free. The removable apparatus comprises an initialization module, a file-scan module, a vendor-verify module, and a digest-check module. The initialization module is for booting up the computing apparatus. The file-scan module is for retrieving the executable file from the computing apparatus. The vendor-verify module is for determining that the executable file comprises no vendor information regarding to a vendor of the executable file. The digest-check module is for calculating a message digest of the executable file by using a message digest algorithm, for determining that the message digest of the executable file is the same as a piece of digest information of the executable file stored in the removable apparatus, and for deciding that the executable file is trustworthy based on the determination of the message digest being the same as the piece of digest information.

Yet a further objective of the present invention is to provide a removable apparatus for verifying an executable file in a computing apparatus. The removable apparatus is virus-free. The removable apparatus comprises an initialization module, a file-scan module, and a vendor-verify module. The initialization module is for booting up the computing apparatus. The file-scan module is for retrieving the executable file from the computing apparatus. The vendor-verify module is for determining that the executable file comprises a piece of vendor information comprising a vendor information part, a designated part, and an encrypted part, for retrieving a vendor public key stored in the removable apparatus according to the vendor information part, for decrypting the encrypted part of the executable file to a decrypted part by using the vendor public key, for determining that the decrypted part is different from the designated part, and for deciding that the executable file is suspicious based on the determination of the decrypted part being different from the designated part.

A further objective of the present invention is to provide a removable apparatus for verifying an executable file in a computing apparatus. The removable apparatus is virus-free. The removable apparatus comprises an initialization module, a file-scan module, and a vendor-verify module. The initialization module is for booting up the computing apparatus. The file-scan module is for retrieving the executable file from the computing apparatus. The vendor-verify module is for determining that the executable file comprises a piece of vendor information comprising a vendor information part, a designated part, and an encrypted part, for retrieving a vendor public key stored in the removable apparatus according to the vendor information part, for decrypting the encrypted part of the executable file to a decrypted part by using the vendor public key, for determining that the decrypted part is the same as the designated part, and for deciding that the executable file is trustworthy based on the determination of the decrypted part being the same as the designated part.

Yet a further objective of the present invention is to provide a removable apparatus for verifying an executable file in a computing apparatus. The removable apparatus is virus-free. The removable apparatus comprises an initialization module, a file-scan module, a vendor-verify module and a digest-check module. The initialization is for booting up the computing apparatus. The file-scan module is for retrieving the executable file from the computing apparatus. The vendor-verify module is for determining that the executable file comprises no vendor information regarding to a vendor of the executable file. The digest-check module is for calculating a first message digest of the executable by using a message digest algorithm and for determining that the removable apparatus comprises no digest information being the same as the message digest. The initialization module is further for shutting down the computing apparatus. The file-scan module is further for retrieving the executable file from the computing apparatus after the computing apparatus is booted up by the computing apparatus. The digest-check module is further for calculating a second message digest of the executable by using the message digest algorithm and then deciding that the first executable file is a malware based on the determination of the first message digest and the second message digest of the executable being different.

According to the aforementioned descriptions, it is understood that the present invention provides a plurality of methods and removable apparatuses for verifying an executable file in a computing apparatus from various angles. Each of the methods can be realized by a plurality of computer instructions stored in a computer readable medium. The present invention uses a trusted removable apparatus (i.e. a virus-free removable apparatus) to boot up a computing apparatus and to verify an executable file stored therein.

In addition, by verifying all executable files comprised in the computing apparatus, the present invention can verify whether the computing apparatus is infected by a virus. If an executable file in the computing apparatus is determined suspicious, it is moved to a designated area of the computing apparatus. After the present invention verifies all the executable files in the computing apparatus, the computing apparatus is determined clean (i.e. trustworthy). Therefore, a computing apparatus can be turned on as a clean one by using the present invention, even it was infected by computer virus.

Since the executable files moved to the designated area are determined as suspicious but not malicious, the present invention provides approaches for further verifying these suspicious executable files. Specifically, the computing apparatus is booted up by the computing apparatus itself. Afterwards, the present invention may verify these suspicious executable files from at least one of the four aspects: vendor information, message digest, trigger-relation, and auto-run situation. For any suspicious executable file, if the verifying result is different from the verifying result last time, the present invention decides that suspicious executable file being malicious.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a first embodiment of the present invention;

FIG. 1B is a schematic view of a second embodiment of the present invention;

FIG. 1C is a schematic view of a third embodiment of the present invention;

FIG. 1D is a schematic view of a fourth embodiment of the present invention;

FIG. 1E is a schematic view of a fifth embodiment of the present invention;

FIG. 2A is a flowchart of a sixth embodiment of the present invention;

FIG. 2B is a sub-flowchart of the sixth embodiment;

FIG. 2C is a sub-flowchart of the sixth embodiment;

FIG. 2D is a sub-flowchart of the sixth embodiment; and

FIG. 3 is a flowchart of the seventh embodiment.

### DESCRIPTION OF THE PREFERRED EMBODIMENT

In the following descriptions, the invention will be explained with reference to the embodiments thereof. However, the description of these embodiments is only for purposes of illustration rather than limitation. It should be noted that in the following embodiments and the attached drawings, elements unrelated to this invention are omitted from depictions; and dimensional relationships among individual elements in the attached drawings are illustrated only for ease of understanding and not for limiting the actual scale.

In the present invention, verifying an executable file means verifying whether the executable file is suspicious and malicious. An executable file is suspicious means that it is possible that the executable file is a malware. In the present invention, an executable file may be verified from the four aspects at a first stage (i.e. an off-line stage). During the off-line stage, the computing apparatus is in an inactive mode; that is, the computing apparatus is booted up by the removable apparatus. The four aspects of verification are (1) whether the executable file is published by a trustworthy software manufacture (i.e. a trusted vendor), (2) whether a message digest of the executable file can be verified (i.e. whether a removable apparatus and/or computer-readable medium comprising a piece of digest information the same as the message digest), (3) whether the executable file has a trigger relation with another executable file, and (4) whether the executable file is an auto-run file. After the four aspects examinations in the first stage, the executable file will be determined as trustworthy or suspicious.

The present invention may proceed to a second stage (i.e. a run-time stage). During the run-time stage, the computing apparatus is in an active mode (i.e. the computing apparatus is booted up by the computing apparatus itself). During the run-time stage, an executable file which is determined as suspicious in the off-line stage is further verified. For a suspicious executable file, if its verification result in the second stage is different from it verification result in the first stage, the possibility of this suspicious executable file being a malware is increased.

The details are described in the following paragraphs.

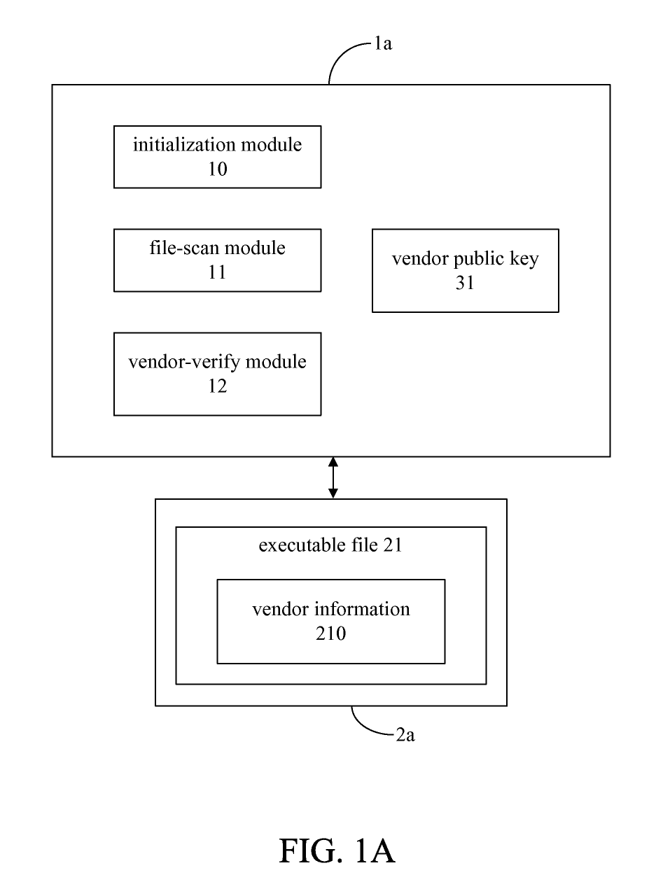

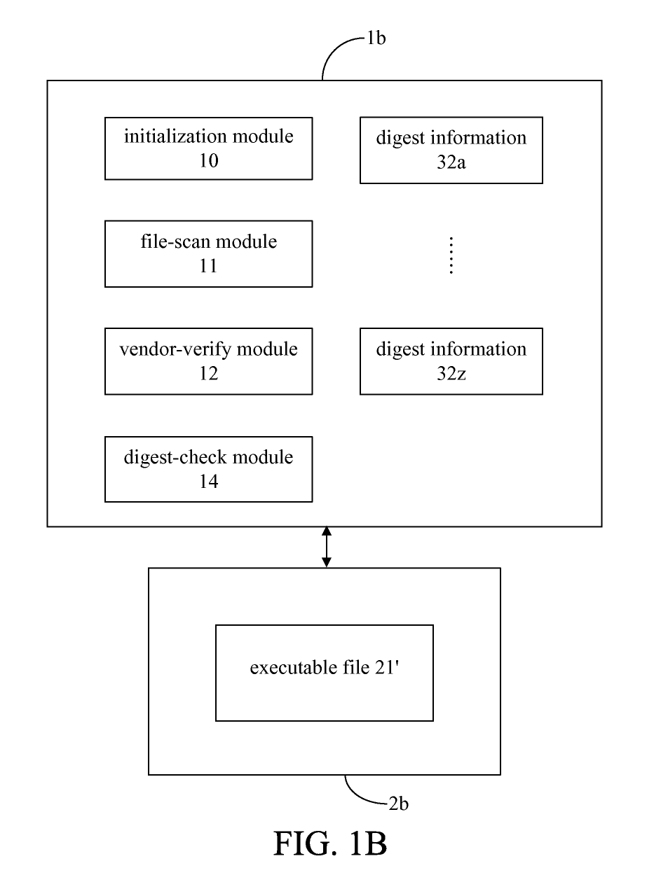

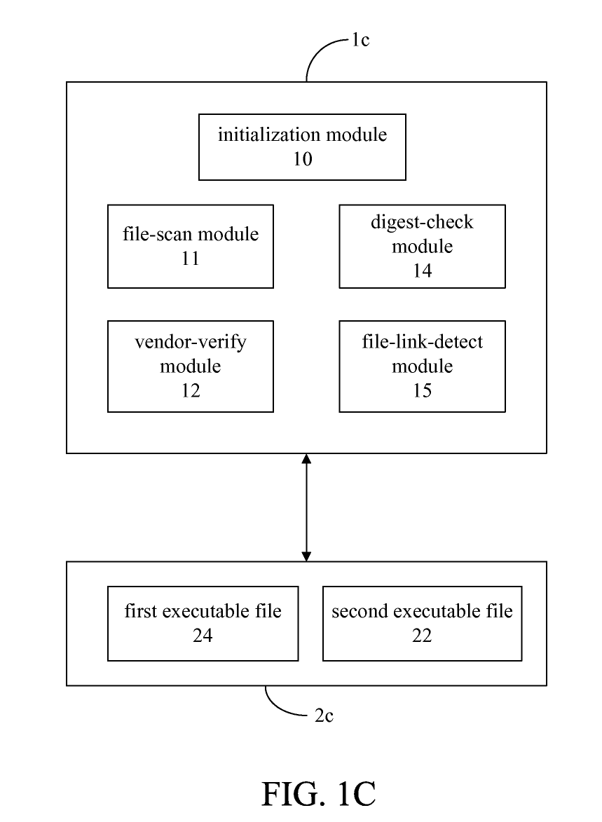

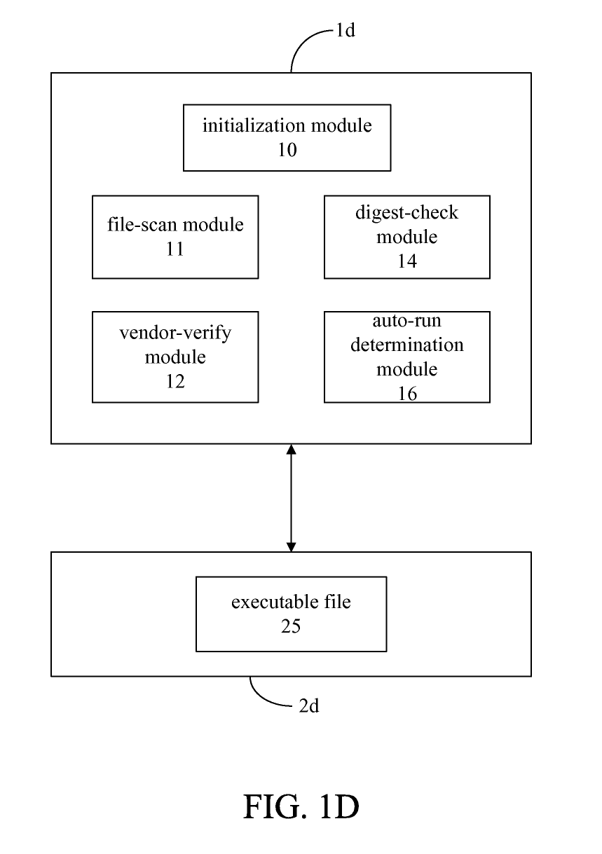

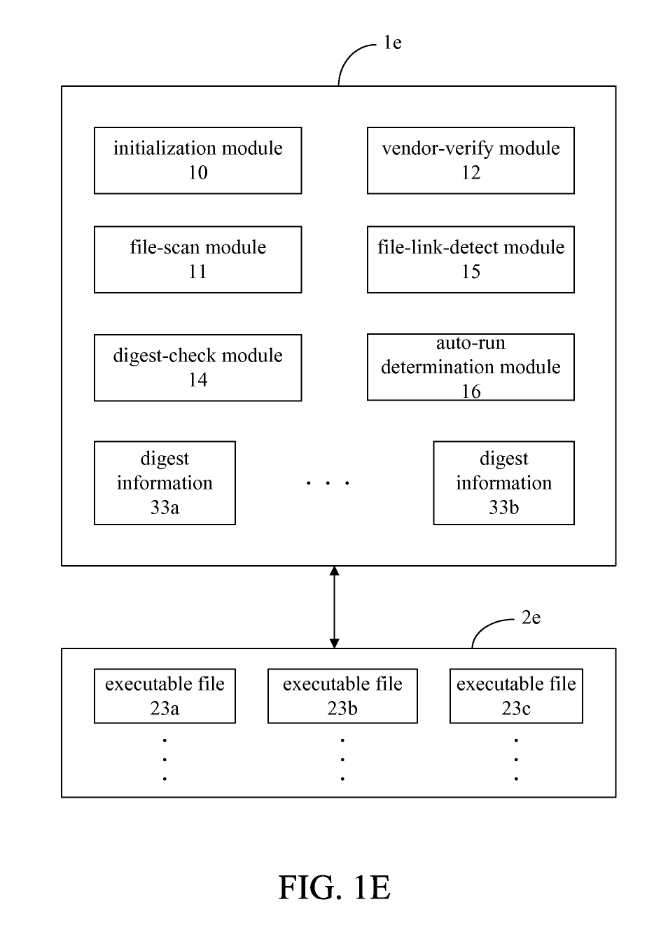

A first embodiment of the present invention is illustrated in FIG. 1A, which shows a removable apparatus 1a for verifying an executable file 21 stored in a computing apparatus 2a. In this embodiment, the executable file 21 is verified whether it is published by a trustworthy software manufacture (i.e. a trusted vendor). In order to verify the executable file 21, a user has to connect the removable apparatus 1a with the computing apparatus 2a. It should be appreciated that the removable apparatus 1a is virus-free and can be any kind of computer storage medium, such as a hard disk, a cd-rom, a dvd-rom, a blur-ray disc, etc. However, the type of computer storage medium is not used to limit the scope of the present invention. In other embodiments, the removable apparatus 1a can be a device with computing abilities, such as a computer. The removable apparatus 1a comprises an initialization module 10, a file-scan module 11, and a vendor-verify module 12.

At the beginning of the off-line stage, the removable apparatus 1a has to be connected to the computing apparatus 2a before the removable apparatus 1a boots up the computing apparatus 2a. In other words, in order to prevent any malware from taking control of the computing apparatus 2a at the beginning, the computing apparatus 2a is set to be booted up by the removable apparatus 1a. Thereafter, the computing apparatus 2a is booted up by the initialization module 10 of the removable apparatus 1a. The initialization module 10 may be an operating system installed in the removable apparatus 1a. After the reliable booting, the file-scan module 11 retrieves the executable file 21 from the computer apparatus 2a. It is noted that the file-scan module 11 of the removable apparatus 1a is able to recognize the file system of the computing apparatus 2a so as to retrieve the executable file 21.

After the retrieval of the executable file 21, the vendor-verify module 12 performs a vendor verification regarding to a vendor of the executable file 21. If the executable file 21 passes the vendor verification, the vendor-verify module 12 decides that the executable file 21 is as a trustworthy one.

First, the vendor-verify module 12 finds out whether the executable file 21 comprises a piece of vendor information regarding to a vendor of the executable file 21 or not. Here, the vendor means the company, institute, etc. that produces the executable file 21. If the vendor-verify module 12 determines that the executable file 21 comprises no vendor information regarding to its vendor, the vendor-verify module 12 determines that the executable file 21 will not perform further vendor verification. If the executable file 21 comprises a piece of vendor information 210, then the vendor-verify module 12 further determines whether the piece of vendor information 210 is genuine or not. The piece of vendor information 210 of the executable file 21 may be associated with a certificate of the executable file 21. For example, if the executable file 21 is designed to be run in the Microsoft Windows, the executable file 21 may comprises a certificate registered to Microsoft Windows when the executable file 21 is published, which makes people and/or machines know that the executable is from the vendor Microsoft. It happens especially when the executable file 21 is published by a well-known software manufacture, because most well-known software manufactures would like to make their softwares to be executed on Microsoft Windows. Certificates play the role of the digital signatures of the softwares published by well-known software manufacture.

Specifically, the piece of vendor information 210 comprises a vendor information part, a designated part, and an encrypted part. The vendor information part indicates which software manufacture produces the executable file 21. For example, if the executable file 21 is published by Oracle, then the vendor information part indicates “Oracle.” The vendor-verify module 12 retrieves a vendor public key 31 from the removable apparatus 1a according to the vendor information part. The vendor-verify module 12 then decrypts the encrypted part of the piece of vendor information 210 of the executable file 21 to a decrypted part by using the vendor public key 31. Afterwards, the vendor-verify module 12 determines whether the decrypted part is the same as the designated part. If the vendor-verify module 12 determines that the decrypted part is the same as the designated part, the vendor-verify module 12 decides that the executable file 21 is trustworthy; that is, the executable file 21 passes the vendor verification. On the contrary, if the vendor-verify module 12 determines that the decrypted part is different from the designated part, the vendor-verify module 12 determines that the executable file 21 is suspicious on account of the executable file 21 may be falsified.

Since the executable file 21 is determined suspicious by the vendor-verify module 12 according to the vendor information 210 during the off-line stage, the executable 21 is recorded on a suspicious list. At a later time, the initialization module 10 shuts down the computing apparatus 2a for leaving the off-line stage. Afterwards, a run-time stage of verification may be performed. The computer apparatus 2a is booted up by the computing apparatus 2a itself for entering the run-time stage. The file-scan module 11 retrieves the executable file 21 recorded on the suspicious list, the vendor verify module 12 then detects whether the executable file 21 has a piece of vendor information or not again. If the vendor information 12 of the executable file 21 has no vendor information this time, it means that the vendor information of the executable file 21 is removed. Thus, the executable file 21 is determined malicious; that is, the possibility of the executable file 21 being a malware is increased.

If the purpose of the verification is to determine whether the executable file 21 is published by a trustworthy software manufacture, the removable apparatus 1a in the first embodiment is able to achieve the task. However, it is possible that a user intends to perform other verifications on the executable file 21. This happens especially when the executable file 21 comprises no vendor information. In that case, the executable file 21 is as suspicious as a malware. A second embodiment of the present invention illustrates the scenario.

Referring to FIG. 1B, which is a schematic diagram of the second embodiment of this invention, a removable apparatus 1b for verifying an executable file 21′ stored in a computing apparatus 2b. The removable apparatus 1b is virus-free (i.e. trustworthy) and stores several pieces of digest information 32a, . . . , 32z. Like the scenario described in the first embodiment, the removable apparatus 1b comprises the initialization module 10, the file-scan module 11, and the vendor-verify module 12. In addition, the removable apparatus 1b comprises a digest-check module 14. The initialization module 10, the file-scan module 11, and the vendor-verify module 12 perform the same functions as those described in the first embodiment, so they are not repeated here. The following descriptions focus on the details of the digest-check module 14. The descriptions are based on the situation when the vendor-verify module 13 determines that the executable 21 comprises no vendor information.

The fact that the executable file 21′ comprises no vendor information means that the executable file 21′ should be temporary treated as a candidate of a malware but not already treated as a malware. The reason is that not all executable files are published by well-known software manufactures and some executable files are customized for particular computers. Executable files that are not published by well-known software manufactures may comprise no vendor information. Accordingly, the executable file 21′ has to be further verified by the digest-check module 14 of the removable apparatus 1b. The digest-check module 14 performs a digest verification on the executable file 21′. If the executable file 21′ passes the digest verification, the digest-check module 14 decides that the executable file 21′ is as a trustworthy one.

First, the digest-check module 14 calculates a first message digest of the executable file 21′ by using a message digest algorithm, such as an MD5 algorithm. Then, the digest-check module 14 determines whether the removable apparatus 1b having a piece of digest information being the same as the first message digest of the executable file 21′. In other words, the digest-check module 14 determines whether any of the pieces of digest information 32a, . . . , 32z is the same as the first message digest of the executable file 21′. If the digest-check module 14 determines that the first message digest is the same as one of the pieces of digest information 32a, . . . , 32z (say, the piece of digest information 32a), the digest-check module 14 then decides that the executable file 21′ is trustworthy.

On the contrary, if the digest-check module 14 determines that none of the pieces of digest information 32a, . . . , 32z is the same as the first message digest, the digest-check module 14 then decides that the executable file 21′ does not pass the digest verification. However, although none of the pieces of digest information 32a, . . . , 32z is the same as the first message digest of the executable file 21′, it does not mean that the executable file 21′ is suspicious, and it only means that the digest-check module 14 cannot judge whether the executable file 21′ is trustworthy. At a later time, the initialization module 10 shuts down the computing apparatus 2b for leaving the off-line stage. A run-time stage may be performed. The computing apparatus 2b is booted up by the computing apparatus 2b itself for entering the run-time stage. The file-scan module 11 starts to retrieve the executable file 21′ recorded on the suspicious list from the computing apparatus 2b. Then the digest-check module 12 calculates a second digest message of the executable file 21′. If the first digest message of the executable file 21′ is different from the second digest message of the executable file 21′, it means that the executable file 21′ has modified its integrity when entering the “run-time” stage. As a result, the digest-check module 14 decides that the executable file 21′ is a malware.

According to the first and second embodiments, it is learned that an executable file is determined as a trustworthy one as long as the executable file passes at least one of the vendor verification performed by the vendor-verify module 12 and the digest verification performed by the digest-check module 14. For an executable file that comprises no the vendor information and does not pass the digest verification, the present invention further verifies it during the off-line stage from other angles as described below.

Before explaining other embodiments, two important concepts need to be explained. First, in the run time procedure of computers, some executable files are not executed by the operating system at the beginning but are triggered by other executable files at a later stage. Second, some executable files are auto-run files. Some malware could take these features for hacking the computers and deceiving the anti-malware software. In order to prevent such behaviors from hacking the computers, an executable file that fails in both the vendor verification performed by the vendor-verify module 12 and the digest verification performed by the digest-check module 14 should be checked with its trigger relation and/or auto-run status.

Referring to FIG. 1C, which is a schematic diagram of a third embodiment of this invention. The third embodiment of this invention is a removable apparatus 1c for verifying the first executable file 24 stored in a computing apparatus 2c. Like the scenario shown in the second embodiment, the removable apparatus 1c comprises the initialization module 10, the file-scan module 11, the vendor-verify module 12, and the digest-check module 14. In addition, the removable apparatus 1c comprises a file-link-detect module 15. The computing apparatus 2c that the removable apparatus 1c connected with comprises the first executable file 24 and a second executable file 22. The initialization module 10, the file-scan module 11, the vendor-verify module 12, and the digest-check module 14 perform the same functions as those described in the first and second embodiments, so they are not repeated here.

The following descriptions are focused on the file-link-detect module 15. That is, the vendor-verify module 12 determines that the first executable file 24 fails in a vendor verification regarding to a vendor of the first executable file and the digest-check module 14 determines that the first executable file 24 fails in a digest verification.

The file-link-detect module 15 detects whether the first executable file 24 has a trigger relation with another executable file in the computing apparatus 2c, such as the second executable file 22. It should be noted that trigger relations of executable files vary from computing apparatus to computing apparatus, so trigger relations are recorded by operating systems of computing apparatuses. Accordingly, if there is a trigger relation between the first executable file 24 and the second executable file 22, the trigger relation is recorded by the operating system (not shown) of the computing apparatus 2c. The trigger relation may be the first executable file 24 being able to be triggered by the second executable file 22 or the first executable file 24 being able to trigger the second executable file 22. If the file-link-detect module 15 detects the first executable file 24 has a trigger relation with the second executable file 22, it means that executing the first executable file 24 may cause the computing apparatus 2c infected by computer virus. Thereby, the file-link-detect module 15 decides that first executable file 24 is suspicious based on the detection of the trigger relation between the first executable file 24 and the second executable file 22.

Since the first executable file 24 is determined suspicious by the file-link-detect module 15 during the off-line stage, it is recorded on a suspicious list. At a later time, the initialization module 10 shuts down the computing apparatus 2c for leaving the off-line stage. A run-time stage may be further performed. The computing apparatus 2c is booted up by the computing apparatus 2c itself for entering the run-time stage. The file-scan module 11 retrieves the first executable file 24 recorded on the suspicious list from the computing apparatus 2c. Then, the file-link-detect module 15 detects whether the first executable file 24 has a trigger relation or not again. If the first executable file 24 is determined having no trigger relation during the run-time stage, it means that the first executable file 24 is a malware it has been modified. If the file-link-detect module 15 determines that the first executable file 24 has a trigger relation with another executable file but not the second executable file 22, it also means that the first executable file 24 has been modified. Under such circumstances, the first executable file 24 is determined as a malware by the file-link-detect module 15.

As mentioned, another type of suspicious behavior is the auto-run, which is addressed in a fourth embodiment. Referring to FIG. 1D, which is a schematic diagram of the fourth embodiment of this invention. The fourth embodiment of this invention is a removable apparatus 1d for verifying the executable file 25 stored in the computing apparatus 2d. Like the scenario shown in the second embodiment, the removable apparatus 1d comprises the initialization module 10, the file-scan module 11, the vendor-verify module 12, and the digest-check module 14. In addition, the removable apparatus 1d comprises an auto-run determination module 16. The initialization module 10, the file-scan module 11, the vendor-verify module 12, and the digest-check module 14 perform the same functions described in the first and second embodiments, so they are not repeated here.

The following descriptions are focused on the auto-run determination module 16. That is, the vendor-verify module 12 determines that the executable file 25 fails in a vendor verification regarding to a vendor of the executable file and the digest-check module 14 determines that the executable 25 fails in a digest verification. The auto-run determination module 16 determines whether the executable file 25 is an auto-run file. Specifically, the auto-run determination module 16 may make the determination by parsing an operating system registration information of the computing apparatus 2d. The auto-run determination module 16 can make the determination because the operating system of the computing apparatus 2d has recorded the auto-run status on the operating system registration information. If the auto-run determination module 16 determines that the executable file 25 is an auto-run file, it further decides that the executable file 25 is suspicious.

Since the executable file 25 is determined suspicious by the auto-run determination module 16 during the off-line stage, it may be further verified later. The executable 25 is recorded on a suspicious list by the auto-run determination module 16 during the off-line stage. At a later time, the initialization module 10 shuts down the computing apparatus 2d for leaving the off-line stage. The run-time stage may be performed. The computing apparatus 2d is booted up by the computing apparatus 2d itself for entering the run-time stage. The file-scan module 11 retrieves the executable file 25 recorded on the suspicious list from the computing apparatus 2d. Then, the auto-run determination module 16 detects whether the executable file 25 has auto-run status or not again. If the auto-run determination module 16 determines that the executable file 25 is not an auto-run file during the run-time stage, the auto-run determination module 16 determines that the executable file 25 is a malware because the executable file 25 has been modified.

FIG. 1E illustrates a fifth embodiment of the present invention, which is a removable apparatus 1e verifying all executable files 23a, 23b, 23c stored in the computing apparatus 2e. The removable apparatus 1e comprises the initialization module 10, the file-scan module 11, the vendor-verify module 12, the digest-check module 14, the file-link-detect module 15, and the auto-run determination module 16. The removable apparatus 2e are stored a plurality of digest information 33a, 33b for digest verification. All the modules and components are able to perform the functions described in the previous embodiments, so they are not repeated here.

The computing apparatus 2e are stored with the executable files 23a, 23b, 23c; however, some of the executable files 23a, 23b, 23c may be suspicious. If the computing apparatus 2e is booted up without any verification in advance, it is possible that more and more of the executable files 23a, 23b, 23c become suspicious ones. To prevent that, the removable apparatus 1e is connected with the computing apparatus 2e in advance. Thereafter, the computing apparatus 2e is booted up by initialization module 10 of the removable apparatus 1e so that the removable apparatus 1e takes the control of the computing apparatus 2e.

The file-scan module 11 retrieves all the executable files 23a, 23b, 23c from the computing apparatus 2e. For each of the executable files 23a, 23b, 23c, the removable apparatus 1e verifies whether it is trustworthy or suspicious.

In this embodiment, if an executable file passes one of the vendor verification performed by the vendor-verify module 12 and the digest verification performed by the digest-check module 14, it is a trustworthy one. If an executable file fails in the vendor verification performed by the vendor-verify module 12, it is decided as suspicious.

If an executable file comprises no vendor information and does not pass the digest verification performed by the digest-check module 14, then that executable file has to be further verified by both the file-link-detect module 15 and/or the auto-run determination module 16. In that case, that executable file has to pass the verifications of both the file-link-detect module 15 and the auto-run determination module 16 to be determined as a trustworthy one. In other words, that executable file cannot have a trigger relation with other executable file and cannot be an auto-run file, otherwise it is determined suspicious. In the fifth embodiment, executable files that are suspicious will be moved to a separated place temporarily.

After all the executable files 23a, 23b, 23c are verified by the removable apparatus 1e, the computing apparatus 2e is determined as a clean one because suspicious executable files are separated. Similarly, the fifth embodiment records the suspicious executable files on a suspicious list. For these suspicious executable files, they may be further verified in a run-time stage. The details of the verifications during the run-time stages are described in the first, second, third, and fourth embodiments, so they are not repeated here.

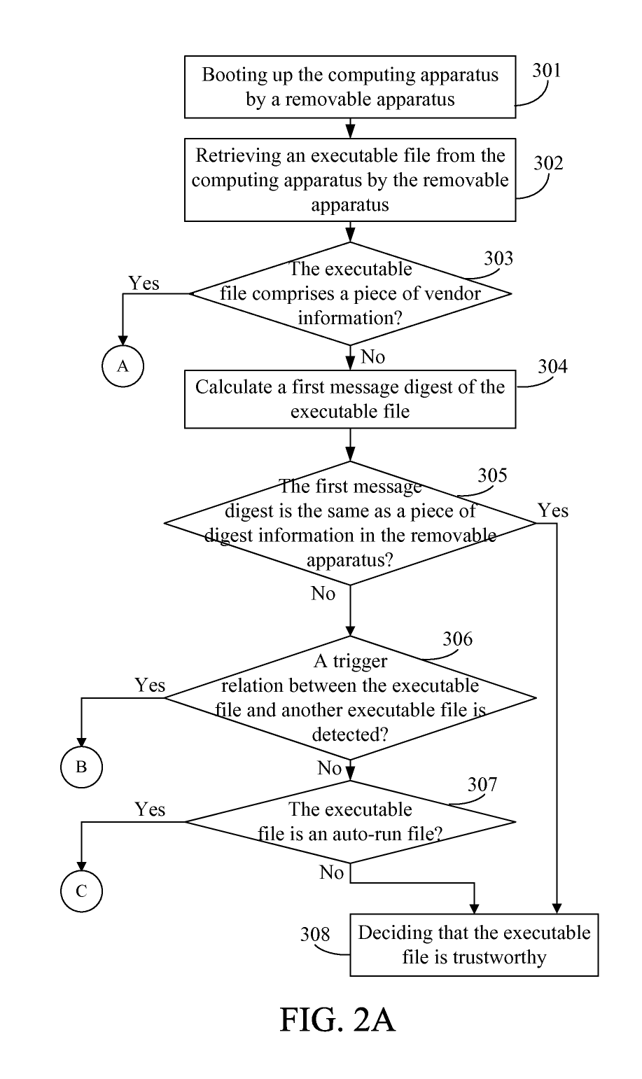

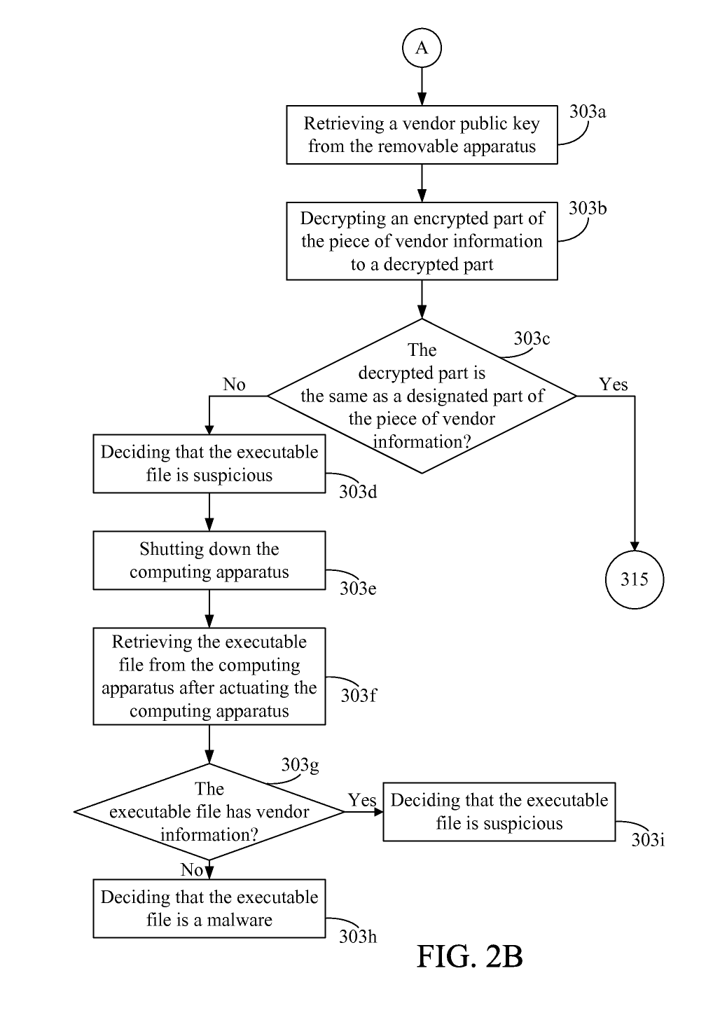

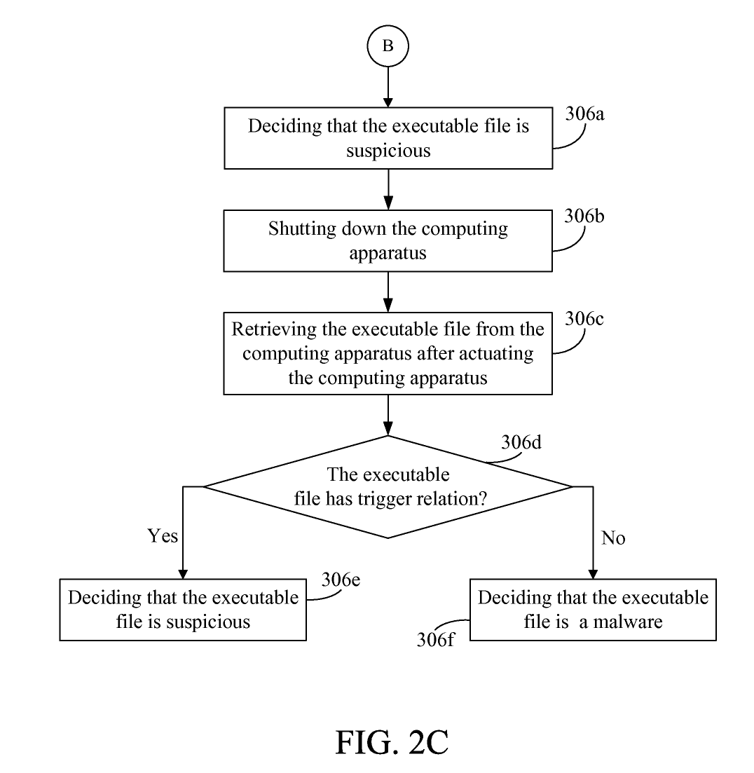

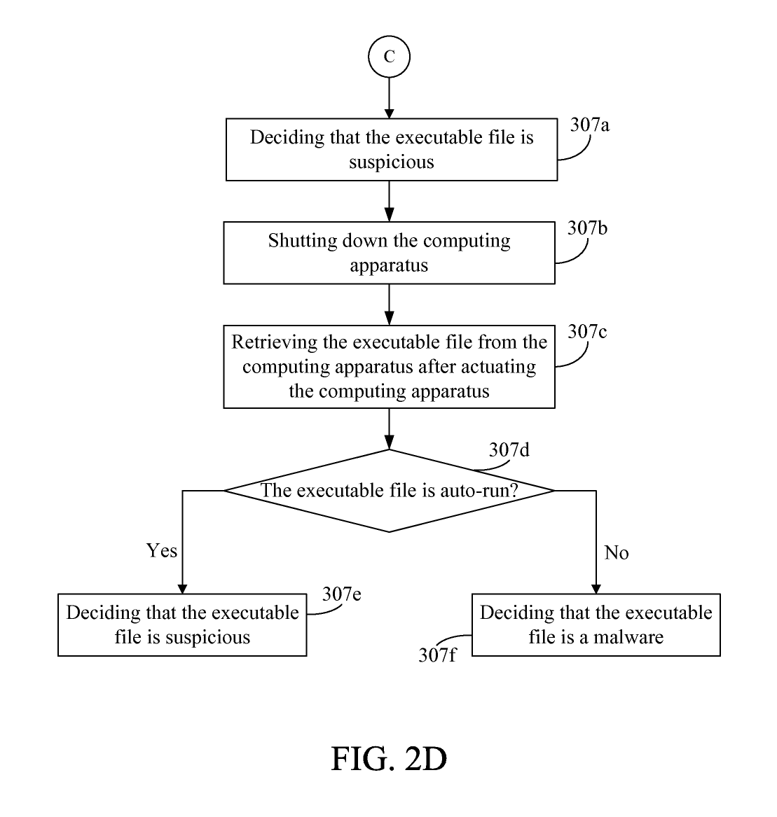

A sixth embodiment of this invention is illustrated in FIGS. 2A-2D, which is a method for verifying an executable file in a computing apparatus such as the computing apparatus 2e described in the above embodiment.

First, the method executes step 301 to boot up the computing apparatus by a removable apparatus, wherein the removable apparatus is virus-free. Next, step 302 is executed to retrieve the executable file from the computing apparatus by the removable apparatus. Then, step 303 is executed to determine whether the executable file comprises a piece of vendor information regarding to a vendor of the executable file by the removable apparatus. If the executable file comprises a piece of vendor information in step 303, then the executable file should be determined that it is genuine or not.

Specifically, checking the correctness of the executable file may be further achieved by the steps illustrates in FIG. 2B. It is noted that the piece of vendor information comprises a vendor information part, a designated part, and an encrypted part. Firstly, step 303a retrieves a vendor public key from the removable apparatus according to the vendor information part. Then, step 303b is executed to decrypt the encrypted part of the piece of vendor information to a decrypted part by using the vendor public key. Next, step 303c is executed to determine whether the decrypted part is the same as the designated part. If the decrypted part is the same as the designated part (i.e. it is yes in step 303c), then step 308 is executed to decide that the executable file is trustworthy. On the contrary, if the decrypted part is different from the designated part (i.e. it is no in step 303c), it means that the executable file could be falsified, and then step 303d is executed to decide that the executable file is suspicious. The executable file decided as suspicious is recorded on a suspicious list. So far, the sixth embodiment is performed at an off-line stage.

The method of the present invention may stop at the step 303d or perform further verification. The sixth embodiment further executes steps 303e to 303i for further verification at a run-time stage. It is noted that steps 303e to 303i does not have to be executed right after step 303d. Steps 303e to 303i may be executed at a later time. At the run-time stage, step 303e is executed to shut down the computing apparatus for the leaving the off-line stage. Step 303f is executed to retrieve the executable file from the computing apparatus after the computing apparatus is booted up by the computing apparatus itself for entering the run-time stage. Then, step 303g is executed to determine whether the executable file has vendor information or not again. If the vendor information of the executable file has no vendor information, it means that either the executable file is modified or the vendor information of the executable file is modified. As a result, step 303h is executed to decide that the executable file is malware. If it is yes in step 303g, step 303i is executed to decide that the executable file is still under the circumstance of being suspicious.

If the executable file comprises no vendor information in step 303, then the method proceeds to step 304. In step 304, the method calculates a message digest of the executable file by using a message digest algorithm, such as MD5 algorithm. Next, in step 305, the method determines whether any digest information stored in the removable apparatus is the same as the message digest of the executable file. If step 305 determines that the message digest is the same as a piece of digest information in the removable apparatus, then the method proceeds to step 308 to decide that the executable file is trustworthy. On the contrary, if step 305 determines that the removable apparatus comprises no digest information being the same as the message digest of the executable file, the method proceeds to step 306.

In step 306, the method detects whether the executable file has a trigger relation with another executable file in the computing apparatus. If a trigger relation between the executable file and another executable file is detected, step 306a is executed to decide the executable file is suspicious. The executable file that is decided suspicious is recorded on a suspicious list. The steps 304, 305, 306, 306a, 308 are executed at off-line stage. The method of the present invention may stop at the step 306a or perform further verification. The sixth embodiment further executes steps 306b to 306f for further verification at a run-time stage. It is noted that steps 306b to 306f does not have to be executed right after step 306a. Steps 306b to 306f may be executed at a later time.

At the run-time stage, step 306b is executed to shut down the computing apparatus for leaving the off-line stage. Step 306c is executed to retrieve the executable file from the computing apparatus after the computing apparatus is booted up by the computing apparatus itself for entering the run-time stage. Then, step 306d is executed to determine whether the executable file has trigger relation or not again. If the executable file has no trigger relation during the run-time stage of the computing apparatus, it means that the executable file is a malware because the executable file has been modified. Then, step 306f is executed to decide that the executable file is malware. Otherwise, step 306e is executed to decide that the executable file is still under the circumstance as suspicious.

On the contrary, if it is no in step 306, then step 307 is executed to determine whether the executable file is an auto-run file. If the executable file is not an auto-run file, step 308 is executed to decide that the first executable is trustworthy. If the executable file is determined as an auto-run file in step 307, the executable file is decided as suspicious in step 307a. The executable file that is decided suspicious is recorded on a suspicious list. The steps 307, 307a, 308 are executed at the off-line stage. The method of the present invention may stop at the step 307a or perform further verification. The sixth embodiment further executes steps 307b to 307f for further verification at a run-time stage. It is noted that steps 307b to 307f does not have to be executed right after step 307a. Steps 307b to 307f may be executed at a later time.

At the run-time stage, step 307b is executed to shut down the computing apparatus for leaving the off-line stage. Step 307c is executed to retrieve the executable file from the computing apparatus after the computing apparatus is booted up by the computing apparatus itself for entering the run-time stage. Then, step 307d is executed to determine whether the executable file is auto-run file or not again. If the executable file is not an auto-run file during the run-time stage of the computing apparatus, it means that the executable file has been modified, so step 307e is executed to decide that the executable file is malware. Otherwise, step 307f is executed to decide that the executable file is still under the circumstance of being suspicious.

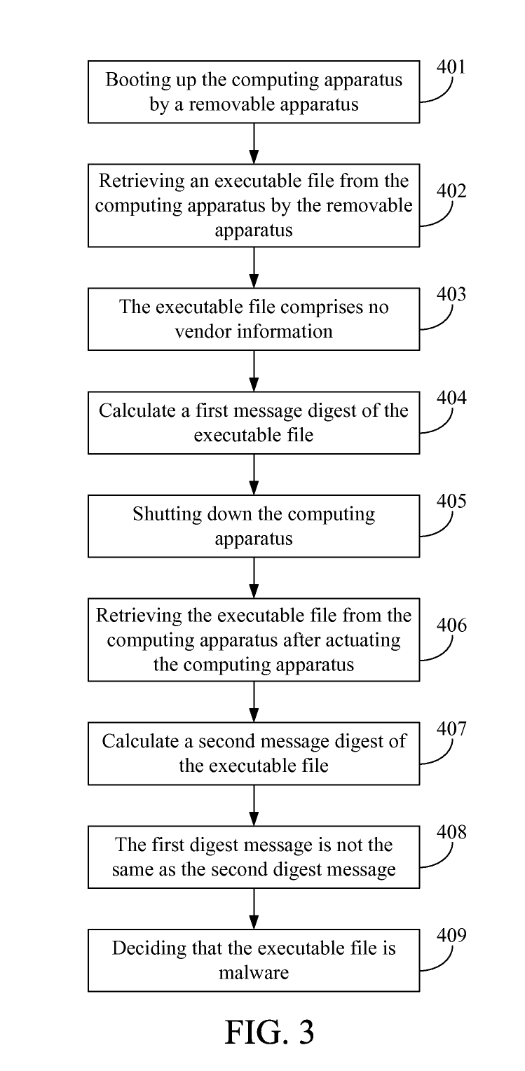

A seventh embodiment of this invention is illustrated in FIG. 3, which is a method for verifying an executable file in a computing apparatus such as the computing apparatus 2e described in the above embodiment.

First, the method executes step 401 to boot up the computing apparatus by a removable apparatus, wherein the removable apparatus is virus-free. Next, step 402 is executed to retrieve the executable file from the computing apparatus by the removable apparatus. Then, step 403 is executed to determine whether the executable file comprises no vendor information regarding to a vendor of the executable file by the removable apparatus.

Step 404 is executed to calculate a first message digest of the executable file. The first message digest of the executable file is recorded on a digest list. At a later time, step 405 is executed to shut down the computing apparatus for leaving the off-line stage. Step 406 is executed to retrieve the executable file from the computing apparatus after the computing apparatus is booted up by the computing apparatus itself for entering the run-time stage. Step 407 is then executed to calculate a second digest message of the executable file for later comparing in step 408.

Specifically, in step 408, it is determined that the first digest message and the second digest message of the executable file are different. It means that the executable file has been modified. Accordingly, step 409 is executed to determine that the executable file is malware.

It should be noted that the off-line stage and the run-time stage of the present invention are operated separately. That is, the present invention may verify all executable files of the computing apparatus from the four aspects at off-line stage. At the off-line stage, some of the executable files are decided as suspicious and these suspicious executable files will be recorded on a suspicious list. After the verification at the off-line stage is complete, the verification at the run-time stage is performed. In the run-time stage, suspicious executable files recorded on the suspicious list are verified again. If the verification result of a suspicious executable file at the run-time stage is different from the verification result at the off-line stage, that suspicious executable file is decided as a malware. Otherwise, that suspicious executable file is still decided as a suspicious one.

In addition to the aforementioned steps, the method for verifying an executable file stored in a computing apparatus of the present invention is able to execute all of the operations and the functions recited in the previous embodiments. Those skilled in this field should be able to straightforwardly realize how the method of the present invention performs these operations and functions based on the above descriptions of the previous embodiments. Thus, no unnecessary detail is given here.

The method of the present invention may be implemented as computer instructions stored on a computer-readable medium. When the computer instructions are loaded into a removable apparatus or a computing apparatus, a plurality of codes are executed to perform the steps of the sixth embodiment. This computer readable medium may be a floppy disk, a hard disk, a compact disk, a mobile disk, a magnetic tape, a database accessible to networks, or any other storage media with the same function and well known to those skilled in the art.

According to the aforementioned description, it is understood that the present invention uses a trusted removable apparatus to boot up a computing apparatus and to verify all executable files in the computing apparatus in two stages. If an executable file is determined suspicious in the “off-line” stage, it is recorded on a suspicious list. After the trusted removable apparatus checks all the executable files in the computing apparatus under the “off-line” stage, a further examination is required. The executable files recorded on the suspicious list will be further examined during the “run-time” stage for being decided whether they are malware or not. Accordingly, the executable files which are determined as suspicious and malware will be moved to a separate place. Therefore, the computing apparatus is determined clean (i.e. trustworthy). Therefore, a computing apparatus can be turned on as a clean one by the removable apparatus of the present invention, even it was infected by computer virus.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for verifying a first executable file in a computing apparatus by a removable apparatus, the removable apparatus being virus-free, the method comprising the steps of:
(a) booting up the computing apparatus by the removable apparatus;
(b) retrieving the first executable file from the computing apparatus by the removable apparatus;
(c) determining that the first executable file comprises no vendor information regarding to a vendor of the first executable file by the removable apparatus;
(d) calculating a message digest of the first executable by the removable apparatus by using a message digest algorithm;
(e) determining that the removable apparatus comprises no digest information being the same as the message digest;
(f) detecting that the first executable file has a trigger relation with a second executable file in the computing apparatus by the removable apparatus; and
(g) deciding that the first executable file is suspicious based on the detection of the trigger relation by the removable apparatus.

2. The method as claimed in claim 1, further comprising the following steps after the step (g):
(h) shutting down the computing apparatus by the removable apparatus;
(i) retrieving the first executable file by the removable apparatus after the computing apparatus is booted up by the computing apparatus;
(j) detecting that the first executable file has no trigger relation with the second executable file in the computing apparatus by the removable apparatus; and
(k) deciding that the first executable file is a malware based on the result of the step (j) by the removable apparatus.

3. The method as claimed in claim 1, wherein the trigger relation is the first executable file being able to be triggered by the second executable file.

4. The method as claimed in claim 1, wherein the trigger relation is the first executable file being able to trigger the second executable file.

5. The method as claimed in claim 1, wherein the trigger relation is recorded by an operating system of the computing apparatus.

6. A method for verifying an executable file in a computing apparatus by a removable apparatus, the removable apparatus being virus-free, the method comprising the steps of:
(a) booting up the computing apparatus by the removable apparatus;
(b) retrieving the executable file from the computing apparatus by the removable apparatus;
(c) determining that the executable file comprises no vendor information regarding to a vendor of the executable file by the removable apparatus;
(d) calculating a message digest of the executable by the removable apparatus by using a message digest algorithm;
(e) determining that the removable apparatus comprises no digest information being the same as the message digest;
(f) determining that the executable file is an auto-run file by the removable apparatus; and
(g) deciding that the executable file is suspicious based on the determination of the step (f) by the removable apparatus.

7. The method as claimed in claim 6, further comprising the following steps after the step (g):
(h) shutting down the computing apparatus by the removable apparatus;
(i) retrieving the executable file from the computing apparatus by the removable apparatus after the computing apparatus is booted up by the computing apparatus;
(j) detecting that the executable file is not an auto-run file by the removable apparatus; and
(k) deciding that the executable file is a malware based on the result of the step (j) by the removable apparatus.

8. The method as claimed in claim 6, wherein the step (f) determines that the executable file is an auto-run file by parsing a piece of operating system registration information of the computing apparatus.

9. A method for verifying an executable file in a computing apparatus by a removable apparatus, the removable apparatus being virus-free, the method comprising the steps of:
(a) booting up the computing apparatus by the removable apparatus;
(b) retrieving the executable file from the computing apparatus by the removable apparatus;
(c) determining that the executable file comprises no vendor information regarding to a vendor of the executable file by the removable apparatus;
(d) calculating a message digest of the executable file by the removable apparatus by using a message digest algorithm;
(e) determining that the message digest of the executable file is the same as a piece of digest information by the removable apparatus, the piece of digest information being stored in the removable apparatus; and
(f) deciding that the executable file is trustworthy based on the determination of the step (e).

10. A method for verifying an executable file in a computing apparatus by a removable apparatus, the removable apparatus being virus-free, the method comprising the steps of:
(a) booting up the computing apparatus by the removable apparatus;
(b) retrieving the executable file from the computing apparatus by the removable apparatus;
(c) determining that the executable file comprises a piece of vendor information by the removable apparatus, the piece of vendor information comprising a vendor information part, a designated part, and an encrypted part;
(d) retrieving a vendor public key according to the vendor information part by the removable apparatus, the vendor public key being stored in the removable apparatus;
(e) decrypting the encrypted part to a decrypted part by the removable apparatus by using the vendor public key;
(f) determining that the decrypted part is different from the designated part; and
(g) deciding that the executable file is suspicious based on the determination of the step (f).

11. The method as claimed in claim 10, further comprising the following steps after the step (g):
(h) shutting down the computing apparatus by the removable apparatus;
(i) retrieving the executable file from the computing apparatus by the removable apparatus after the computing apparatus is booted up by the computing apparatus;
(j) detecting that the executable file has no vendor information by the removable apparatus; and
(k) deciding that the first executable file is a malware based on the result of the step (j) by the removable apparatus.

12. The method as claimed in claim 10, wherein the piece of vendor information is associated with a certificate of the executable file.

13. A method for verifying an executable file in a computing apparatus by a removable apparatus, the removable apparatus being virus-free, the method comprising the steps of:
(a) booting up the computing apparatus by the removable apparatus;
(b) retrieving the executable file from the computing apparatus by the removable apparatus;
(c) determining that the executable file comprises a piece of vendor information by the removable apparatus, the piece of vendor information comprising a vendor information part, a designated part, and an encrypted part;
(d) retrieving a vendor public key according to the vendor information part by the removable apparatus, the vendor public key being stored in the removable apparatus;
(e) decrypting the encrypted part to a decrypted part by the removable apparatus by using the vendor public key;
(f) determining that the decrypted part is the same as the designated part; and
(g) deciding that the executable file is trustworthy based on the determination of the step (f).

14. The method as claimed in claim 13, wherein the piece of vendor information is associated with a certificate of the executable file.

15. A method for verifying an executable file in a computing apparatus by a removable apparatus, the removable apparatus being virus-free, the method comprising the steps of:
(a) booting up the computing apparatus by the removable apparatus;
(b) retrieving the executable file from the computing apparatus by the removable apparatus;
(c) determining that the executable file comprises no vendor information regarding to a vendor of the executable file by the removable apparatus;
(d) calculating a first message digest of the executable file by the removable apparatus by using a message digest algorithm;
(e) determining that the removable apparatus comprises no digest information being the same as the message digest;
(f) shutting down the computing apparatus by the removable apparatus;
(g) retrieving the executable file from the computing apparatus by the removable apparatus after the computing apparatus is booted up by the computing apparatus;
(h) calculating a second message digest of the executable file by the removable apparatus by using the message digest algorithm;
(i) determining that the first message digest and the second message digest of the executable file are different; and
(j) deciding that the executable file is a malware based on the result of the step (i) by the removable apparatus.

16. A removable apparatus for verifying a first executable file in a computing apparatus, the removable apparatus being virus-free and comprising:
an initialization module, for booting up the computing apparatus;
a file-scan module, for retrieving the first executable file from the computing apparatus;
a vendor-verify module, for determining that the first executable file comprises no vendor information regarding to a vendor of the executable file;
a digest-check module, for calculating a message digest of the first executable by using a message digest algorithm and for determining that the removable apparatus comprises no digest information being the same as the message digest; and
a file-link-detect module, for detecting that the first executable file has a trigger relation with a second executable file in the computing apparatus and for deciding that the first executable file is suspicious based on the detection of the trigger relation.

17. The removable apparatus as claimed in claim 16, wherein the initialization module further shuts down the computing apparatus, the file-scan module further retrieves the first executable file from the computing apparatus after the computing apparatus is booted up by the computer apparatus, and the file-link-detect module further detects that the first executable file has no trigger relation with the second executable file in the computing apparatus and then decides that the first executable file is a malware based on the detection of the first executable having no trigger relation.

18. The removable apparatus as claimed in claim 16, wherein the trigger relation is the first executable being able to be triggered by the second executable file.

19. The removable apparatus as claimed in claim 16, wherein the trigger relation is the first executable being able to trigger the second executable file.

20. The removable apparatus as claimed in claim 16, wherein the trigger relation is recorded by an operating system of the computing apparatus.

21. A removable apparatus for verifying an executable file in a computing apparatus, the removable apparatus being virus-free and comprising:
an initialization module, for booting up the computing apparatus;
a file-scan module, for retrieving the executable file from the computing apparatus;
a vendor-verify module, for determining that the executable file comprises no vendor information regarding to a vendor of the executable file;
a digest-check module, for calculating a message digest of the executable by using a message digest algorithm and for determining that the removable apparatus comprises no digest information being the same as the message digest; and
an auto-run determination module, for determining that the executable file is an auto-run file and for deciding that the executable file is suspicious based on the determination of the executable file being the auto-run file.

22. The removable apparatus as claimed in claim 21, wherein the initialization module further shuts down the computing apparatus, the file-scan module further retrieves the executable file from the computing apparatus after the computing apparatus is booted up by the computing apparatus, and the auto-run determination module further detects that the executable file is not auto-run file and then decides that the executable file is a malware based on the determination of the executable file being not auto-run file.

23. The removable apparatus as claimed in claim 21, wherein the auto-run determination module determines that the executable file is an auto-run file by parsing a piece of operating system registration information of the computing apparatus.

24. A removable apparatus for verifying an executable file in a computing apparatus, the removable apparatus being virus-free and comprising:
an initialization module, for booting up the computing apparatus;
a file-scan module, for retrieving the executable file from the computing apparatus;
a vendor-verify module, for determining that the executable file comprises no vendor information regarding to a vendor of the executable file;
a digest-check module, for calculating a message digest of the executable file by using a message digest algorithm, for determining that the message digest is the same as a piece of digest information stored in the removable apparatus, and for deciding that the executable file is trustworthy based on the determination of the message digest being the same as the piece of digest information.

25. A removable apparatus for verifying an executable file in a computing apparatus, the removable apparatus being virus-free and comprising:
an initialization module, for booting up the computing apparatus;
a file-scan module, for retrieving the executable file from the computing apparatus; and
a vendor-verify module, for determining that the executable file comprises a piece of vendor information comprising a vendor information part, a designated part, and an encrypted part, for retrieving a vendor public key stored in the removable apparatus according to the vendor information part, for decrypting the encrypted part of the executable file to a decrypted part by using the vendor public key, for determining that the decrypted part is different the designated part, and for deciding that the executable file is suspicious based on the determination of the decrypted part being different from the designated part.

26. The removable apparatus as claimed in claim 25, wherein the initialization module further shuts down the computing apparatus, the file-scan module further retrieves the executable file from the computing apparatus after the computing apparatus is booted up by the computing apparatus, and the vendor-verify module further determines that the executable file comprises no vendor information and then decides that the executable file is a malware based on the determination of the executable file comprising no vendor information.

27. The removable apparatus as claimed in claim 25, wherein the piece of vendor information is associated with a certificate of the executable file.

28. A removable apparatus for verifying an executable file in a computing apparatus, the removable apparatus being virus-free and comprising:
an initialization module, for booting up the computing apparatus;
a file-scan module, for retrieving the executable file from the computing apparatus; and
a vendor-verify module, for determining that the executable file comprises a piece of vendor information comprising a vendor information part, a designated part, and an encrypted part, for retrieving a vendor public key stored in the removable apparatus according to the vendor information part, for decrypting the encrypted part of the executable file to a decrypted part by using the vendor public key, for determining that the decrypted part is the same as the designated part, and for deciding that the executable file is trustworthy based on the determination of the decrypted part being the same as the designated part.

29. The removable apparatus as claimed in claim 28, wherein the piece of vendor information is associated with a certificate of the executable file.

30. A removable apparatus for verifying an executable file in a computing apparatus, the removable apparatus being virus-free and comprising:
an initialization module, for booting up the computing apparatus;
a file-scan module, for retrieving the executable file from the computing apparatus;
a vendor-verify module, for determining that the executable file comprises no vendor information regarding to a vendor of the executable file; and
a digest-check module, for calculating a first message digest of the executable by using a message digest algorithm and for determining that the removable apparatus comprises no digest information being the same as the message digest;
wherein the initialization module further shuts down the computing apparatus, the file-scan module further retrieves the executable file from the computing apparatus after the computing apparatus is booted up by the computing apparatus, and the digest-check module further calculates a second message digest of the executable by using the message digest algorithm, determines that the first message digest and the second message digest of the executable file are different, and then decides that the first executable file is a malware based on the determination of the first message digest and the second message digest of the executable being different.

31. A computer-readable medium for storing a plurality of computer instructions, the computer-readable medium being virus-free, the computer instructions verifying a first executable file in a computing apparatus when being executed and comprising:
code A for booting up the computing apparatus;
code B for retrieving the first executable file from the computing apparatus;
code C for determining that the first executable file comprises no vendor information regarding to a vendor of the first executable file;
code D for calculating a message digest of the first executable by the removable apparatus by using a message digest algorithm;
code E for determining that the removable apparatus comprises no digest information being the same as the message digest;
code F for detecting that the first executable file has a trigger relation with a second executable file in the computing apparatus; and
code G for deciding that the first executable file is suspicious based on the detection of the trigger relation.

32. The computer-readable medium as claimed in claim 31, further comprising the following codes after the code G:
code H for shutting down the computing apparatus;
code I for retrieving the first executable file from the computing apparatus after the computing apparatus is booted up by the computing apparatus;
code J for detecting that the first executable file has no trigger relation with the second executable file in the computing apparatus; and
code K for deciding that the first executable file is a malware based on the result of the step J.

33. The computer-readable medium as claimed in claim 31, wherein the trigger relation is the first executable file being able to be triggered by the second executable file.

34. The computer-readable medium as claimed in claim 31, wherein the trigger relation is the first executable file being able to trigger the second executable file.

35. The computer-readable medium as claimed in claim 31, wherein the trigger relation is recorded by an operating system of the computing apparatus.

36. A computer-readable medium for storing a plurality of computer instructions, the computer-readable medium is virus-free, the computer instructions verifying an executable file in a computing apparatus when being executed and comprising:
code A for booting up the computing apparatus;
code B for retrieving the executable file from the computing apparatus;
code C for determining that the executable file comprises no vendor information regarding to a vendor of the executable file;
code D for calculating a message digest of the executable by the removable apparatus by using a message digest algorithm;
code E for determining that the removable apparatus comprises no digest information being the same as the message digest;
code F for determining that the executable file is an auto-run file; and
code G for deciding that the executable file is suspicious based on the execution result of the code E.

37. The computer-readable medium as claimed in claim 36, further comprising the following codes after the code G:
code H for shutting down the computing apparatus;
code I for retrieving the executable file from the computing apparatus after the computing apparatus is booted up by the computing apparatus;
code J for detecting that the executable file is not auto-run file; and
code K for deciding that the executable file is a malware based on the result of the code J.

38. The computer-readable medium as claimed in claim 36, wherein the code F determines that the executable file is an auto-run file by parsing a piece of operating system registration information of the computing apparatus.

39. A computer-readable medium for storing a plurality of computer instructions, the computer-readable medium being virus-free, the computer instructions verifying an executable file in a computing apparatus when being executed and comprising:
code A for booting up the computing apparatus;
code B for retrieving the executable file from the computing apparatus;
code C for determining that the executable file comprises no vendor information regarding to a vendor of the executable file;
code D for calculating a message digest of the executable file by using a message digest algorithm;
code E for determining that the message digest of the executable file is the same as a piece of digest information stored in the computer-readable medium;
code F for deciding that the executable file is trustworthy based on the execution result of the code E.

40. A computer-readable medium for storing a plurality of computer instructions, the computer-readable medium being virus-free, the computer instructions verifying an executable file in a computing apparatus when being executed and comprising:
code A for booting up the computing apparatus;
code B for retrieving the executable file from the computing apparatus;
code C for determining that the executable file comprises a piece of vendor information, the piece of vendor information comprising a vendor information part, a designated part, and an encrypted part;
code D for retrieving a vendor public key from the computer-readable medium according to the vendor information part;
code E for decrypting the encrypted part of the executable file to a decrypted part by using the vendor public key; and
code F for determining that the decrypted part is different from the designated part; and
code G for deciding that the executable file is suspicious based on the execution result of the code F.

41. The computer-readable medium as claimed in claim 40, further comprising the following codes after the code G:
code H for shutting down the computing apparatus;
code I for retrieving the executable file from the computing apparatus after the computing apparatus is booted up by the computing apparatus;
code J for detecting that the executable file has no vendor information; and
code K for deciding that the first executable file is a malware based on the result of the code J.

42. The computer-readable medium as claimed in claim 40, wherein the piece of vendor information is associated with a certificate of the executable file.

43. A computer-readable medium for storing a plurality of computer instructions, the computer-readable medium being virus-free, the computer instructions verifying an executable file in a computing apparatus when being executed and comprising:
code A for booting up the computing apparatus;
code B for retrieving the executable file from the computing apparatus;
code C for determining that the executable file comprises a piece of vendor information, the piece of vendor information comprising a vendor information part, a designated part, and an encrypted part;
code D for retrieving a vendor public key from the computer-readable medium according to the vendor information part;
code E for decrypting the encrypted part of the executable file to a decrypted part by using the vendor public key; and
code F for determining that the decrypted part is the same as the designated part; and
code G for deciding that the executable file is trustworthy based on the execution result of the code F.

44. The computer-readable medium as claimed in claim 43, wherein the piece of vendor information is associated with a certificate of the executable file.

45. A computer-readable medium for storing a plurality of computer instructions, the computer-readable medium being virus-free, the computer instructions verifying an executable file in a computing apparatus when being executed and comprising:
code A for booting up the computing apparatus by the removable apparatus;
code B for retrieving the executable file from the computing apparatus by the removable apparatus;
code C for determining that the executable file comprises no vendor information regarding to a vendor of the executable file by the removable apparatus;
code D for calculating a first message digest of the executable file by the removable apparatus by using a message digest algorithm;
code E for determining that the removable apparatus comprises no digest information being the same as the message digest;
code F for shutting down the computing apparatus by the removable apparatus;
code G for retrieving the executable file from the computing apparatus after the computing apparatus is booted up by the computing apparatus;
code H for calculating a second message digest of the executable file by the removable apparatus by using the message digest algorithm;
code I for deciding that the first message digest and the second message digest of the executable file are different; and
code J for deciding that the executable file is a malware based on the result of the code I.
